(19) United States
(12) Patent Application Publication
(10) Pub. No.: US 2017/0188254 A1
(43) Pub. Date: Jun. 29, 2017

(54) SYSTEM AND METHOD FOR ON-LINE IDENTIFICATION OF ACTIVE VIRTUAL MOBILE BASE-STATIONS, BASED ON ACTIVE NETWORK MEASUREMENTS

(71) Applicant: Wave Guard Technologies Ltd., Herzeliya (IL)

(72) Inventor: David SHAUL, Kfar-Saba (IL)

(21) Appl. No.: 15/305,043

(22) PCT Filed: Apr. 30, 2015
(86) PCT No.: PCT/IL2015/050453

§ 371 Date: Oct. 18, 2016

(30) Foreign Application Priority Data
May 1, 2014 (IL) 232423

(51) Int. Cl. H04W 24/10; H04W 48/16; H04W 24/02

(52) U.S. Cl. CPC H04W 24/10; H04W 24/02; H04W 48/16; H04W 88/08

(57) ABSTRACT

A computerized system for continuously monitoring, detecting and identifying of active virtual mobile base-stations, based on active mobile network measurements, which comprises a configuration topology database for providing data related to the active site of a mobile network; a processing unit, connected to the database, for receiving data files from radio access elements of the radio access network (RAN) of the mobile network and collecting its network configuration topology data, collecting event data messages related to mobile subscribers of the mobile network and being transferred between the mobiles' user equipment and radio access network elements and comparing mobile subscriber's event data with the network configuration topology data; a virtual base-station identification detector, for receiving from the processing unit the comparison results being indicative of virtual base-station activity and generating an identification and profile data file of the virtual base-station, based on the comparison results.

### FIELD OF THE INVENTION

The present invention is related to on-line identification of active virtual mobile base-stations on one or more mobile networks, based on active mobile network measurements. More particularly, the invention relates to a continuous on-line monitoring and detection of mobile base-station that are not part of the radio access network topology.

### BACKGROUND OF THE INVENTION

Network performance improvement is part of the daily routine of the mobile network's radio access engineer. Daily operational activates performed by the mobile operators are a key stone in maintaining network's Grade of Service and customer satisfaction. The technological progress and the range of different co-exiting radio mobile access technologies and mobile infrastructure vendor's product, as well as the increase ramification of the mobile communication networks makes operation and the radio access engineering activity very complex and multi-dimensional. Detecting and resolving network anomalies using a software based system allows the operator to detect any interference or network anomalies caused by using virtual BTSs (vBTS), which are not part of the radio access network topology, yet transmit on the mobile operator's frequency band, to allow better mobile subscribes' tracing. Connecting the proposed system to a plurality of mobile operators' networks will enable detecting the anomalies created by the virtual BTSs on wider range of frequency spectrum and geographical areas.

In a typical mobile radio system, Base Stations (BSs) and mobile User Equipment units (UE unit—any device used directly by an end-user to communicate) communicate with voice and data signals via a Radio Access Network (RAN) to one or more core networks. BSs are typically mobile base stations, which consist of transceivers and antennas. A BS has different types of physical and logical dimensions, for example macro BS, micro BS, femto BS and a Small cell. The mobile UEs are mobile devices, such as mobile telephones, smart mobile phones, PDAs, tablets and laptops with mobile termination. The core network is the central part of a telecom network that provides various services to customers who are connected to it.

The RAN covers a geographical area which is divided into cells, each of which is served by a base station. A cell area is a geographical area, in which radio coverage is provided by the radio equipment in the corresponding base station. Each cell is identified by a unique identity, which is broadcasted by the cell. The base stations and the cells are part of the radio access network topology. The base station communicates over the air interface (e.g., using radio frequencies) with the mobile UEs within the cell area. In typical RANs, several base stations are typically connected (e.g., by landlines or microwave channels) to a Radio Network Controller (RNC). The RNC (also known as a Base Station Controller) supervises and coordinates various activities of the plurality of base stations connected to it. The RNCs are typically connected to one or more core networks.

The Long Term Evolution (LTE) and the LTE Advanced (LTE-A) in the Universal Mobile Telecommunications System (UMTS a mobile cellular system for networks based on the GSM standard), are standards for wireless communication of high-speed data for mobile phones and data terminals. They are based on the GSM/EDGE (Enhanced Data rates for GSM Evolution—a digital mobile phone technology that allows improved data transmission rates) and UMTS/HSPA (High Speed Packet Access a technology that extends and improves the performance of existing 3rd generation mobile telecommunication networks utilizing WCDMA protocols) network technologies, for increasing the capacity and speed using new modulation techniques. This standard is developed by the 3GPP (3rd Generation Partnership Project—collaboration between groups of telecommunications associations). The Universal Mobile Telecommunications System (UMTS) is a third generation mobile communication system, which evolved from the Global System for Mobile Communications (GSM), and is intended to provide improved mobile communication services, based on Wideband Code Division Multiple Access (WCDMA) technology. CDMA-based systems use a wider frequency band to achieve the same rate of transmission as FDMA (Frequency-Division Multiple Access). In a forum known as the Third Generation Partnership Project (3GPP), telecommunications suppliers proposed and agreed upon standards for third generation networks and specifically, Universal Terrestrial Radio Access Network (UTRAN). The UTRAN contains mobile base stations (also known as NodeBs and evolved-NodeBs) and Radio Network Controllers (RNCs) and evolved RNC (e-RNC). The RNC/e-RNC provides control functionalities for one or more NodeBs/e-NodeBs. A Node B contains radio frequency transmitters and receivers used to communicate directly with the mobile UEs, which move freely around it.

In recent years, there is an increase in the amount of tactical transmission equipment which is not part of the transmitting topology of the mobile access networks that affects both the normal mobile network's behavior and performance. These also affect the normal behavior of the mobile subscriber's communication confidentiality. As a result, there is a need for detecting that plurality of tactical transmission equipment, in order to maximize the spectrum efficiency (which is typically a limited resource); Mobile networks are adapted to produce real-time event messages. An event message is a measurement report sent between different components in the mobile network (e.g., eNodeBs E-UTRAN Node B, RNC, Node B, UE, etc.). Event messages can be categorized to several types, depending on the types of measurements encapsulated within them, and on the network components participating in the messaging process.

In addition, technological standard organizations such as the 3GPP forum, investigated enhanced ways to control and manage the operation of third generation networks with advance measurement. One result of the forum's work is the UTRAN Iur interface Radio Network Subsystem Application Part (RNSAP) signaling, as described in 3GPP TS 25.423 V3.14.2 (2012) standard, for example. This standard specifies the radio network layer signaling procedures of the control plane between RNCs in UTRAN, in which the transmitted frequency use and power are ones of those measurements.

Pre-requisite for on-line identification of active virtual mobile base-stations based on active mobile network measurement is to have the mobile access network topology's data, which contains all related mobile radio access transmission elements.

Today, mobile radio networks operators and law enforcement agencies are looking for ways for an on-line identification of active virtual mobile base-stations, based on active mobile network measurements for dynamically react to the non-heterogeneous, multi-layer network interference and secure service demands by their customers. However, such capability presents many technical challenges and difficulties. None of the currently available field tactical techniques can provide a wide area scale identifications of such virtual base-stations. Therefore, there is a need for a system that provides a continuous monitoring and on-line identification of active virtual mobile base-stations based on active mobile network measurements from multi type/technologies/layer and vendors, in real time.

It is therefore an object of the present invention to provide a software system for automatically and continuously on-line identification of active virtual mobile base-stations based on active mobile network measurements.

It is another object of the present invention to provide a system for guaranteeing that mobile network operator, which be able to continuously maintain its network's grade of service to their customers and at any given time and location.

It is a further object of the present invention to accurately detect the location of the virtual mobile based station activators and thus prevent during the mobile network operation, any mobile operators' possible negative network performance and security breach effects.

It is yet another object of the present invention to accurately and remotely assist the activity of law enforcement agencies in fighting this phenomenon of virtual base station activation, which directly affects the mobile operators revenues and branding.

It is still another object of the present invention to provide functional compatibility between different sources of data, from several network infrastructure vendors (e.g., ZTE, HUAWEI, Ericsson, NOKIA-NSN, Alcatel-Lucent, Motorola, etc.).

It is yet another object of the present invention is to provide a cost-effective system for detecting network security breach.

Other objects and advantages of the invention will become apparent as the description proceeds.

### SUMMARY OF THE INVENTION

The present invention is directed to a computerized system for continuously monitoring, detection and identification of active virtual mobile base-stations, based on active mobile network measurements, which comprises:
a. a configuration topology database for providing data related to the active site of a mobile network;
b. a processing unit, connected to the database, for:
   b.1) receiving data files from radio access elements of the radio access network (RAN) of the mobile network and collecting its network configuration topology data;
   b.2) collecting event data messages related to mobile subscribers of the mobile network and being transferred between the mobiles' user equipment and radio access network elements;
   b.3) comparing mobile subscriber's event data with the network configuration topology data; and
c. a virtual base-station identification detector, for:
   c.1) receiving from the processing unit the comparison results being indicative of virtual base-station activity; and
   c.2) generating an identification and profile data file of the virtual base-station, based on the comparison results.

The virtual base-station that communicates with the mobile (subscriber) User Equipment (UE) via Air Interface may not be a part of mobile operator's wireless radio access telecommunication transmitting sources.

The processing unit may be adapted to essentially on-line process and analyze virtual base-station measurements reported by mobile subscriber user equipment to build the identification profile of the virtual base-station.

The data files may be data files which comprise real-time event messages transferred between the mobiles' user equipment and different radio access network elements.

The processing unit may comprise:
a. a profile decoder for building the virtual base-station profile from the; and
b. a decompounder for comparing the virtual base-station data profile with the active base-station in the mobile network as measured in the event measurement file and reported in the configuration topology file.

The decompounder extracts the virtual base-station data from the mobile user equipment's measurements at any given report record and includes one or more decoders, adapted to analyze the data files received from each mobile network, in parallel.

The decompounder may further compare the event measurements data from the User Equipment units (UEs) with the network topology data for detecting virtual base-station measurement data.

The proposed system may further comprise a history database containing history data record definitions of any track record of virtual base-station identification event including event handling definitions and track recording.

The virtual base-station identification detector may be adapted to generate an alert upon detecting a mismatch between the data corresponding to the radio access network configuration topology and the mobile subscriber's event.

The present invention is also directed to a method for online identification and profiling of active virtual base-station, comprising:
a. receiving data files from the mobile access networks;
b. indexing data file immediately after its creation;
c. extracting the base-station related data measurement from the files by decompunding relevant measurements from the communication protocol layers;
d. comparing the base-station related data measurement with the network's topology configuration from the different network topologies data, stored in a database; and
e. generating one or more profiles of the virtual base-stations identification.

The data in the history database may be utilized for identifying virtual base-station activation patterns and behaviors for further use by law enforcement agencies.

### BRIEF DESCRIPTION OF THE DRAWINGS

The above and other characteristics and advantages of the invention will be better understood through the following illustrative and non-limitative detailed description of embodiments thereof, with reference to the appended drawings, wherein:

FIG. 1 is a schematic illustration of an online identification system for active virtual mobile base-stations under one or plural mobile networks, in accordance with an embodiment of the present invention; and

FIG. 2 is a schematic flow chart illustration of the virtual base station identification processes performed by the system, constructed and operated in accordance with an embodiment of the present invention.

### DETAILED DESCRIPTION OF THE INVENTION

The present invention is directed to software based system for on-line identification of active virtual mobile base-stations, based on continuous analysis of mobile access network's event measurement which comprises:

a. An online software processing element, for data collection and gathering information from one or more multi-type mobile radio access networks. The data gathered will be the base for on-line identification of active virtual mobile base-stations, for example for improving customer grade of service, operational anomalies reduction and law enforcement agencies' needs.

b. a data collection and profiling server, connected to the software, for verifying and analyzing the network data gathered before implementing the behavior detection algorithms. The software processing element receives data files from one or more, multi-vendor, multi-technology mobile radio access. The BS and the transmitting sources may be wireless radio telecommunication transmitting sources. The software processing unit may process and analyze the mobile networks and multiplicity of mobile users' data of each mobile access network and identify, generate profiles and alerts on activation of virtual base-station under the mobile's network geographical areas; The software processing unit may be also adapted to support better mobile's user performance and better spectrum interference handling and quality of service.

c. The software processing unit may comprise:
a. a data manager, for extracting the relevant data from the network's data files;
b. a customer device geo corresponder for aliening the related data from the different subscribers' mobile reports; and
c. an on-line identification element, essentially in real time or close to real time.

The software data manager extracts, for example, the frequency spectrum use data, the Network's Quality of Service data class performance and other data related to traffic and radio access engineering of each network elements. It may encompass one or more decoders, adapted to analyze the data files received from the mobile user and BS, in parallel.

A multi-point, multi-technology and multi-mobile networks monitoring and measurement capabilities may be enabled via a single software monitoring and identification system.

Software managed national mobile network spectral data may be used within large geographical area.

Real measurement may be transformed into multiple location mobile's operational management centers.

The data files may be, for example, binary data files that comprise real-time event messages, being transferred between components in the monitored radio access elements.

In the following description, for the purpose of illustration, numerous specific details are provided. As will be apparent to the skilled person, however, the invention is not limited to such specific details and the skilled person will be able to devise alternative arrangements.

The key idea proposed by the present invention is to dynamically and automatically perform virtual base-station identification process related to the ongoing operation of multi technology, multi-vendor wireless radio access and core networks. On-going identification during normal mobile network's operation is designed to assure that base-stations that are not part of the mobile access network topology element will not take part of the mobile subscriber radio link transmission. The system proposed by the present invention is capable of transforming raw data from several mobile networks into a form of ongoing online identification process that will be able to alert such event and will be able to address each detected event with a proper action. Online Identification and properly addressing the detected event can improve the mobile network behavior, quality and un-optimal operational activity. Each radio access controller element in the mobile network executes live relevant measurement for controlling and managing its functionality. The system proposed by the present invention uses those accurate controller elements and measurements and performs analysis and identification of virtual base-station activation process, in order to reduce any harmful effect on the mobile subscriber and the mobile network, in order to achieve superior network performance. The present invention proposes a method for transforming real measurement into an operational virtual base-station alert, based on variant multi-layer algorithms designed to address performance criteria of parallel multi-layer heterogeneous networks.

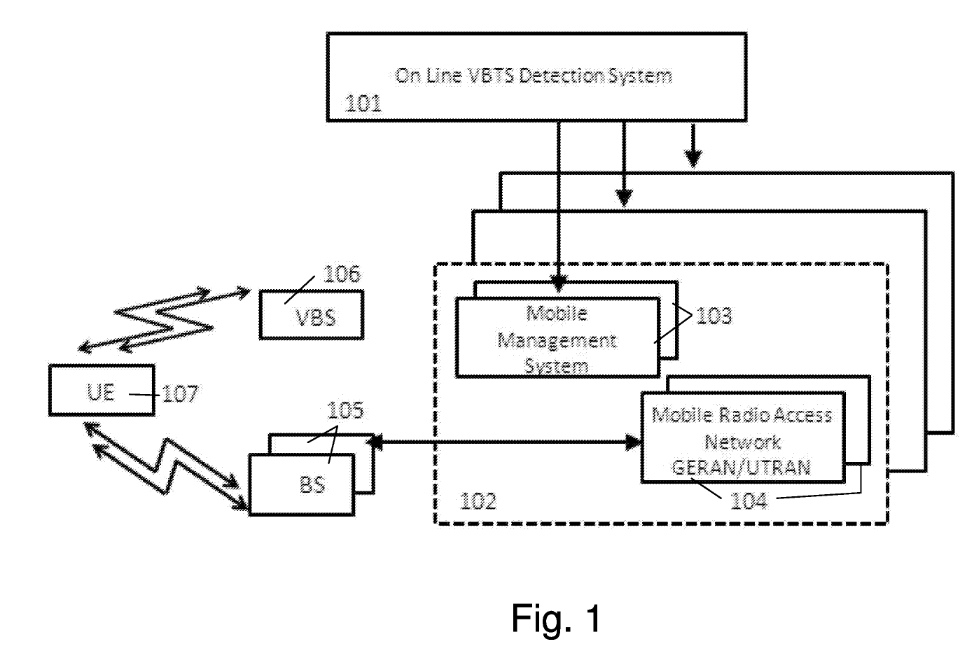

FIG. 1 is a high level schematic illustration of an on-line identification system of active Virtual Mobile Base-Stations Identification System (VBTSI), constructed and operative in accordance with an embodiment of the present invention. The Virtual Base-Station Identification System (VBTSI) 101 is the supported mobile operation system, which interfaces with the one or plurality existing Mobile Management & Operation Support Subsystems (OSS) 103 which is part of the Mobile Operating Network (MON) 102. Each Mobile Operating Network 102 also consists of Mobile Radio Access Network (RAN) 104. The Mobile Radio Access Network is a 3GPP technology based network (GSM-GERAN/3G-UTRAN/LTE-EUTRAN). The radio access networks also consist of base stations (BS) 105. The Base Stations are multi-type (macro/micro/femto/small-cell); 3GPP technology based network element (GSM-BS/3G-NodeB/LTE-eNodeB). The Mobile User Equipment (UE) 107 interfaces the Base Station through the Air-Interface. A Virtual Base-Station (VBTS) 106 is not part of the Operator's Mobile Network and is not connected to it. However, the Mobile User Equipment (UE) 107 can communicate with the Virtual Base-Station (VBTS) 106, as well, through the Air Interface. The present invention comprises of software modules, which continuously perform Virtual Base-station identifications and operational profiling processes based on data monitoring.

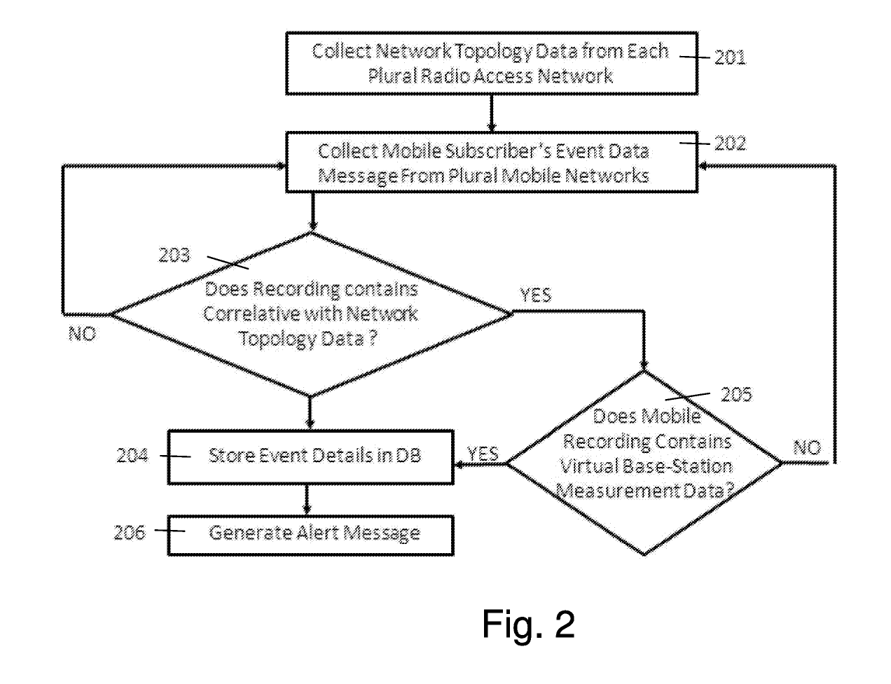

FIG. 2 is a is a schematic flow chart illustration of the virtual base station identification process performed by the system, constructed and operated in accordance with one embodiment of the present invention. In the first process stage 201, a collection of Network Topology Data is performed from one or more Mobile Access Networks. In a relaying process stage 202, a collection of Mobile Subscriber's Event Data Messages is performed from one or more Mobile Access Networks. The next process 203 verifies whether the event message content data and analysis yield network message anomalies, for example un-synchronized, reject or Failure event messages from Mobile User Equipment. When such a case is detected, a correlation with the Network Data Topology is performed to detect whether the examined case relates to malfunctioning of mobile access radio element, operated under mobile operator's radio access topology definition, or the detected case relates to an Active Virtual Base Station (VBTS). If the detected case is analyzed to be a potential Active Virtual Base Station (VBTS), then the next process is to store the identified event detailed data in the database, and parallel to that a profile on the Active Virtual Base Station (VBTS) is generated and also stored in the database for further use. The system also alerts the detection event and displays the gathered event information and profile of the suspected Active Virtual Base Station (VBTS).

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

It will be appreciated that the present invention is not limited by what has been described hereinabove and that numerous modifications, all of which fall within the scope of the present invention, exist. Rather the scope of the invention is defined by the claims.

1. A computerized system for continuously monitoring, detecting and identifying active virtual mobile base-stations, based on active mobile network measurements, comprising:
a. a configuration topology database for providing data related to the active site of a mobile network;
b. a processing unit, connected to said database, for:
b.1) receiving data files from radio access elements of the radio access network (RAN) of said mobile network and collecting its network configuration topology data;
b.2) collecting event data messages related to mobile subscribers of said mobile network and being transferred between the mobiles' user equipment and radio access network elements;
b.3) comparing mobile subscriber's event data with said network configuration topology data; and
c. a virtual base-station identification detector, for:
c.1) receiving from said processing unit the comparison results being indicative of virtual base-station activity; and
c.2) generating an identification and profile data file of said virtual base-station, based on the comparison results.

2. A system according to claim 1, wherein the virtual base-station that communicates with the mobile subscriber equipment (UE) via Air Interface is not a part of mobile operator's wireless radio access telecommunication transmitting sources.

3. A system according to claim 1, wherein the processing unit processes and analyzes virtual base-station measurements reported by mobile subscriber user equipment to build the identification profile of the virtual base-station.

4. A system according to claim 1, wherein the processing unit processes and analyzes the mobile and network measurement data essentially on-line.

5. A system according to claim 1, wherein the data files are data files which comprise real-time event messages transferred between the mobiles' user equipment and different radio access network elements.

6. A system according to claim 1, wherein the processing unit comprises:
a. a profile decoder for building said virtual base-station profile from the measurements reported by mobile subscriber user equipment; and
b. a decompounder for comparing said virtual base-station data profile with the active base-station in the mobile network as measured in the event measurement file and reported in the configuration topology file.

7. A system according to claim 6, wherein the decompounder extracts the virtual base-station data from the mobile user equipment's measurements at any given report record.

8. A system according to claim 6, wherein the decompounder includes one or more decoders, adapted to analyze the data files received from each mobile network, in parallel.

9. A system according to claim 6, wherein the corresponder further compares the event measurements data from the User Equipment units (UEs) with the network topology data for detecting virtual base-station measurement data.

10. A system according to claim 1, further comprising a history database containing history data record definitions of any track record of virtual base-station identification event including event handling definitions and track recording.

11. A method for online identification and profiling of an active virtual base-station, comprising:
a. receiving data files from said mobile access networks;
b. indexing data file immediately after its creation;
c. extracting the base-station related data measurement from said files by decompunding relevant measurements from the communication protocol layers;
d. comparing said base-station related data measurement with the network's topology configuration from the different network topologies data, stored in a database; and
e. generating one or more profiles of the virtual base-stations identification.

12. The method of claim 11, further comprising utilizing the data in the history database for identifying virtual base-station activation patterns and behaviors for further use by law enforcement agencies.

13. A system according to claim 1, wherein the virtual base-station identification detector is adapted to generate an alert upon detecting a mismatch between the data corresponding to the radio access network configuration topology and the mobile subscriber's event.
